(19) United States
(12) Patent Application Publication
(10) Pub. No.: US 2017/0206462 A1
(43) Pub. Date: Jul. 20, 2017

(54) METHOD AND APPARATUS FOR DETECTING ABNORMAL CONTENTION ON A COMPUTER SYSTEM

(71) Applicant: International Business Machines Corporation, Armonk, NY (US)

(72) Inventors: Karla K. Arndt, Rochester, MN (US); Joseph W. Gentile, New Paltz, NY (US); Nicholas R. Jones, Poughkeepsie, NY (US); Nicholas C. Matsakis, Poughkeepsie, NY (US); David H. Surman, Marlboro, NY (US)

(21) Appl. No.: 14/995,248

(22) Filed: Jan. 14, 2016

(51) Int. Cl. G06N 99/00; G06F 17/30; G06F 9/54; G06F 9/50

(52) U.S. Cl. CPC G06N 99/005; G06F 9/5011; G06F 17/30312; G06F 9/542

(57) ABSTRACT

Aspects relate to a computer implemented method for detecting abnormal contention. The computer implemented method includes collecting resource modeling data for a serially reusable resource, wherein the resource modeling data includes one or more of request count data and contention data and storing, in a computer readable storage medium, the resource modeling data in an in-memory database. The method also includes creating and training a first model and a second model using the resource modeling data and one or more cognitive computing tasks and categorizing a contention event as an abnormal contention event using the first model and the second model.

### BACKGROUND

The present disclosure relates generally to detecting abnormal contention and, more specifically, to a method and apparatus for detecting abnormal contention on a computer system for a serially reusable resource.

In computer system workloads there are often a number of transactions that make up jobs, and a number of jobs that make up a program, which are all vying for some of the same limited resources, some of which are serially reusable resources such as memory, processors, and software instances. In such computer system workloads, there may be many relationships between jobs, transactions, and programs that are increasingly dynamic creating complex resource dependency scenarios that can cause delay. For example, when a thread or unit of work involved in a workload blocks a serially reusable resource, it slows itself down and other jobs and/or transactions going on concurrently across the system, the entire system complex, or cluster of systems, which are waiting for the resource. In mission critical workloads, such delays may not be acceptable to the system and a user.

Additional delays may be caused by human factors. For example, one such factor that can lead to delays in a reduction of IT staff in an IT shop or department as well as the inexperience of the IT staff below a threshold for providing sufficient support thereby causing delays. Some automation may be utilized to help alleviate delay, however, automation may not have enough intrinsic knowledge of the system to detect or make decisions regarding delays or the causes of the blocking jobs.

There are other approaches today that help in the attempt to avoid or detect serialization issues within a system or across a distributed environment such as deadlock detectors that either avoid or detect deadlocks and possibly take action such as terminating or rolling back a requestor to end the deadlock. Other approaches can be provided that use one metric to determine if there is an abnormality on the system that could indicate a damaged system or can indicate existing contention based on the fact that there are jobs waiting for the resource currently or have been for a specific length of time.

An operating system of the future is envisioned that can monitor such workloads and automatically detect abnormal contention (with greater accuracy) to help recover from delays in order to provide increased availability and throughput of resources for users. These types of analytics and cluster-wide features may help keep valuable systems operating competitively at or above desired operating thresholds.

### SUMMARY

In accordance with an embodiment, a method for detecting abnormal contention is provided. The method includes collecting, using a processor, resource modeling data for a serially reusable resource, wherein the resource modeling data includes one or more of request count data and contention data and storing, in a computer readable storage medium, the resource modeling data in an in-memory database. The method also includes creating and training, using the processor, a first model and a second model, using the resource modeling data and one or more cognitive computing tasks and categorizing, using the processor, a contention event as an abnormal contention event using the first model and the second model.

In accordance with another embodiment, a system for detecting abnormal contention is provided. The system includes a memory having computer readable instructions and one or more processors for executing the computer readable instructions. The computer readable instructions include collecting resource modeling data for a serially reusable resource, wherein the resource modeling data includes one or more of request count data and contention data and storing, in the memory, the resource modeling data in an in-memory database. The computer readable instructions also include creating and training a first model and a second model using the resource modeling data and one or more cognitive computing tasks and categorizing a contention event as an abnormal contention event using the first model and the second model.

In accordance with a further embodiment, a computer program product for detecting abnormal contention includes a non-transitory storage medium readable by a processing circuit and storing instructions for execution by the processing circuit for performing a method. The program instructions executable by a processor to cause the processor to collect resource modeling data for a serially reusable resource, wherein the resource modeling data includes one or more of request count data and contention data, store the resource modeling data in an in-memory database, create and train a first model and a second model using the resource modeling data and one or more cognitive computing tasks, and categorize a contention event as an abnormal contention event using the first model and the second model.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The forgoing and other features, and advantages are apparent from the following detailed description taken in conjunction with the accompanying drawings in which:

FIG. 1 depicts a block diagram of a computer system in accordance with some embodiments of this disclosure;

FIG. 2 depicts a block diagram of a computer system for implementing some or all aspects of the system, according to some embodiments of this disclosure;

FIG. 3 depicts a process flow of a method for detecting abnormal contention in accordance with some embodiments of this disclosure;

FIG. 4 depicts a process flow of collecting resource modeling data for a method for detecting abnormal contention in accordance with some embodiments of this disclosure; and

FIG. 5 depicts a process flow of categorizing a contention event for a method for detecting abnormal contention in accordance with some embodiments of this disclosure.

### DETAILED DESCRIPTION

It is understood in advance that although this disclosure includes a detailed description on a single computer system, implementation of the teachings recited herein are not limited to a computer system and environment. Rather, embodiments of the present invention are capable of being implemented in conjunction with any other type of computing environment now known or later developed such as systems that include multiple computers or clusters of systems.

Embodiments described herein are directed to detecting abnormal contention. For example, in this disclosure one or more methods and apparatus for a system to detect abnormal delays resulting from access to serially reusable resources is introduced. A serially reusable resource is any part of a system that can be used by more than one program, job, and/or thread but for which access must be controlled such that either the serially reusable resource can be used one at a time only (exclusive access which is usually akin to making updates or if there is only one) or the resource can be shared simultaneously, but only if the program, job, and/or threads are only reading. According to one or more embodiments, the serially reusable resource can be one selected from a group consisting of, but not limited to, a computer memory, a computer processor, a computer program, a computer data bus, a file, a row in a database table, a piece of code that touches certain memory objects, a database structure in memory, a control block in memory, a shared device, a data set on a shared device, data buffers, and registers.

One or more of the disclosed embodiments use cognitive computing techniques on a specialized in-memory database, for improved detection performance. Additionally, one or more of the embodiments correlates multiple metrics and multiple types of cognitive computing techniques such as classification, regression, and clustering algorithms to ensure accurate detection result. An advantage of one or more of the embodiments is an ability to learn normal system behavior with regard to contention, by modeling multiple factors which characterize contention. By using multiple described techniques, one or more of the embodiments predicts normal versus abnormal contention with high accuracy.

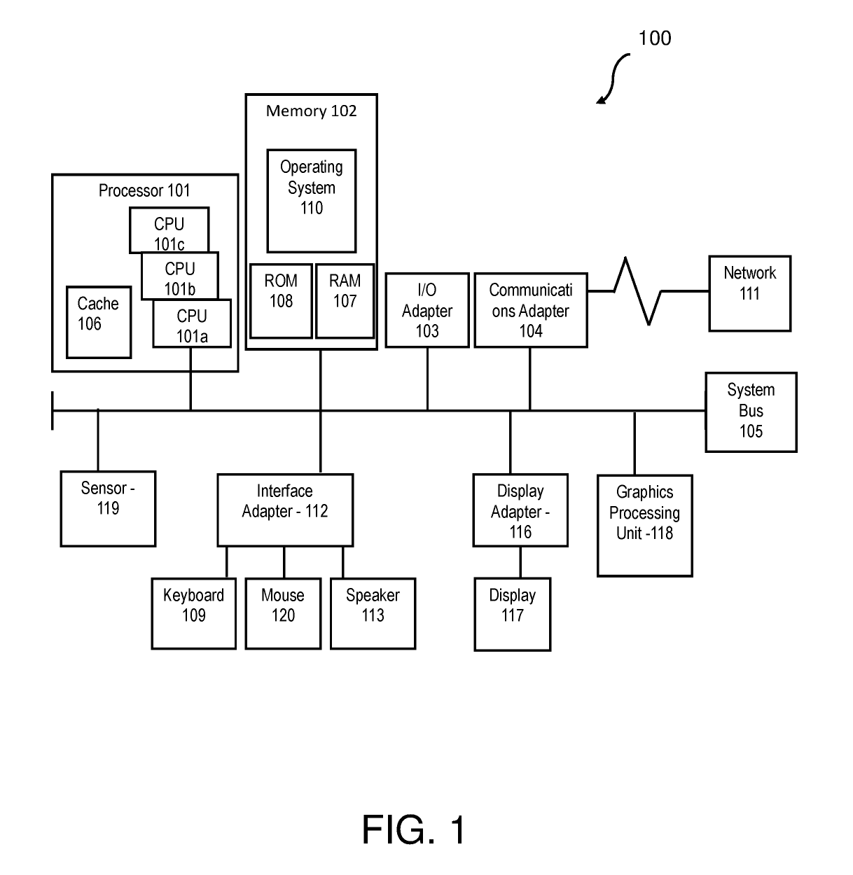

Turning now to FIG. 1, an electronic computing device 100, which may also be called a computer system 100 that includes a plurality of electronic computing device sub-components any one of which may include or itself be a serially reusable resource is generally shown in accordance with one or more embodiments. Particularly, FIG. 1 illustrates a block diagram of a computer system 100 (hereafter “computer 100”) for use in practicing the embodiments described herein. The methods described herein can be implemented in hardware, software (e.g., firmware), or a combination thereof. In an exemplary embodiment, the methods described herein are implemented in hardware, and may be part of the microprocessor of a special or general-purpose digital computer, such as a personal computer, workstation, minicomputer, or mainframe computer. Computer 100 therefore can embody a general-purpose computer. In another exemplary embodiment, the methods described herein are implemented as part of a mobile device, such as, for example, a mobile phone, a personal data assistant (PDA), a tablet computer, etc. According to another embodiment, the computer system 100 may be an embedded computer system. For example, the embedded computer system 100 may be an embedded system in a washing machine, an oil drilling rig, or any other device that can contain electronics.

In an exemplary embodiment, in terms of hardware architecture, as shown in FIG. 1, the computer 100 includes processor 101. Computer 100 also includes memory 102 coupled to processor 101, and one or more input and/or output (I/O) adaptors 103, that may be communicatively coupled via a local system bus 105. Communications adaptor 104 may be operatively connect computer 100 to one or more networks 111. System bus 105 may also connect one or more user interfaces via interface adaptor 112. Interface adaptor 112 may connect a plurality of user interfaces to computer 100 including, for example, keyboard 109, mouse 120, speaker 113, etc. System bus 105 may also connect display adaptor 116 and display 117 to processor 101. Processor 101 may also be operatively connected to graphical processing unit 118.

Further, the computer 100 may also include a sensor 119 that is operatively connected to one or more of the other electronic sub-components of the computer 100 through the system bus 105. The sensor 119 can be an integrated or a standalone sensor that is separate from the computer 100 and may be communicatively connected using a wire or may communicate with the computer 100 using wireless transmissions.

Processor 101 is a hardware device for executing hardware instructions or software, particularly that stored in a non-transitory computer-readable memory (e.g., memory 102). Processor 101 can be any custom made or commercially available processor, a central processing unit (CPU), a plurality of CPUs, for example, CPU 101a-101c, an auxiliary processor among several other processors associated with the computer 100, a semiconductor based microprocessor (in the form of a microchip or chip set), a macroprocessor, or generally any device for executing instructions. Processor 101 can include a memory cache 106, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 106 may be organized as a hierarchy of more cache levels (L1, L2, etc.).

Memory 102 can include random access memory (RAM) 107 and read only memory (ROM) 108. RAM 107 can be any one or combination of volatile memory elements (e.g., DRAM, SRAM, SDRAM, etc.). ROM 108 can include any one or more nonvolatile memory elements (e.g., erasable programmable read only memory (EPROM), flash memory, electronically erasable programmable read only memory (EEPROM), programmable read only memory (PROM), tape, compact disc read only memory (CD-ROM), disk, cartridge, cassette or the like, etc.). Moreover, memory 102 may incorporate electronic, magnetic, optical, and/or other types of non-transitory computer-readable storage media. Note that the memory 102 can have a distributed architecture, where various components are situated remote from one another, but can be accessed by the processor 101.

The instructions in memory 102 may include one or more separate programs, each of which comprises an ordered listing of computer-executable instructions for implementing logical functions. In the example of FIG. 1, the instructions in memory 102 may include a suitable operating system 110. Operating system 110 can control the execution of other computer programs and provides scheduling, input-output control, file and data management, memory management, and communication control and related services.

Input/output adaptor 103 can be, for example but not limited to, one or more buses or other wired or wireless connections, as is known in the art. The input/output adaptor 103 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

Interface adaptor 112 may be configured to operatively connect one or more I/O devices to computer 100. For example, interface adaptor 112 may connect a conventional keyboard 109 and mouse 120. Other output devices, e.g., speaker 113 may be operatively connected to interface adaptor 112. Other output devices may also be included, although not shown. For example, devices may include but are not limited to a printer, a scanner, microphone, and/or the like. Finally, the I/O devices connectable to interface adaptor 112 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like.

Computer 100 can further include display adaptor 116 coupled to one or more displays 117. In an exemplary embodiment, computer 100 can further include communications adaptor 104 for coupling to a network 111.

Network 111 can be an IP-based network for communication between computer 100 and any external device. Network 111 transmits and receives data between computer 100 and external systems. In an exemplary embodiment, network 111 can be a managed IP network administered by a service provider. Network 111 may be implemented in a wireless fashion, e.g., using wireless protocols and technologies, such as WiFi, WiMax, etc. Network 111 can also be a packet-switched network such as a local area network, wide area network, metropolitan area network, Internet network, or other similar type of network environment. The network 111 may be a fixed wireless network, a wireless local area network (LAN), a wireless wide area network (WAN) a personal area network (PAN), a virtual private network (VPN), intranet or other suitable network system.

If computer 100 is a PC, workstation, laptop, tablet computer and/or the like, the instructions in the memory 102 may further include a basic input output system (BIOS) (omitted for simplicity). The BIOS is a set of essential routines that initialize and test hardware at startup, start operating system 110, and support the transfer of data among the operatively connected hardware devices. The BIOS is stored in ROM 108 so that the BIOS can be executed when computer 100 is activated. When computer 100 is in operation, processor 101 may be configured to execute instructions stored within the memory 102, to communicate data to and from the memory 102, and to generally control operations of the computer 100 pursuant to the instructions.

According to one or more embodiments, any one of the electronic computing device sub-components of the computer 100 includes, or may itself be, a serially reusable resource that receives a number of job requests. According to one or more embodiments, a job is abstract and can include a program, a thread, a process, a subsystem, etc., or a combination thereof. Further, according to one or more embodiments, a job can include one or more threads within a program or different programs. Accordingly, one or more contention events may occur at any such serially reusable resource element. Further, the contention events may be normal or abnormal which may be detected using a method or apparatus in accordance with one or more of the disclosed embodiments herewith.

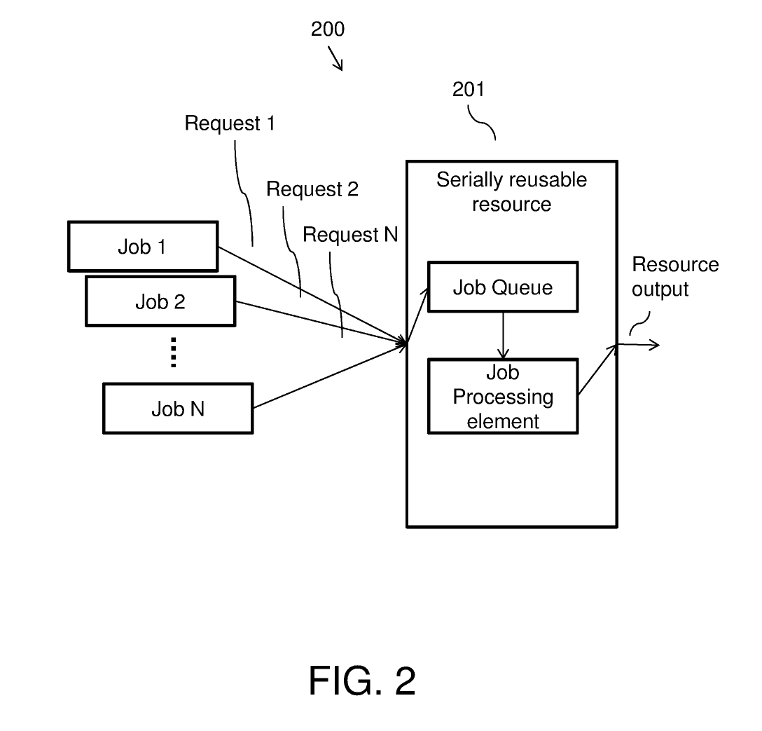

For example, turning now to FIG. 2, a component 200 of a computer system 100 as shown in FIG. 1 is shown. The component 200 may be a cluster of systems, a single system, a cluster of computers in a system, a single computer, a sub-element of a computer such as a CPU, a memory (ROM, RAM, L1 cache, L2 cache), or one of the other elements shown in FIG. 1. The component 200 may also be a computer program product comprising a computer readable storage medium having program instructions embodied therewith, the program instructions executable by a processor.

The component 200 includes a serially reusable resource 201. The serially reusable resource 201 can itself be any element that operates serially thereby leading to contention events when an additional job requests usage when the serially reusable resource 201 is already processing a current job. For example, the serially reusable resource 201 can itself be a cluster of systems, a single system, a cluster of computers in a system, a single computer, a sub-element of a computer such as a CPU, a memory (ROM, RAM, L1 cache, L2 cache), or one of the other shown elements of FIG. 1. The serially reusable resource 201 may also be a computer program product comprising a computer readable storage medium having program instructions embodied therewith, the program instructions executable by a processor. According to one or more embodiments, the serially reusable resource 201 can be serialized via any serialization method which may be operating system dependent as well as programming language dependent (e.g., mutex, semaphore, enqueuer, latch, lock, etc.).

As shown in FIG. 2, the serially reusable resource 201 has a serial path through which jobs are received, queued, processed, and outputs are transmitted. For example, a Job 1 can send a Request 1 to the serially reusable resource 201. If no other jobs are present the serially reusable resource 201 will move the job in through the queue to the job processing element where it will be processed. The job being processed therefore has temporary ownership of the serially reusable resource while the job is processed. Once completed the resource output is transmitted out. Further, Job 2 all the way through Job N may also send Request 2 all the way through Request N, respectively, to the serially reusable resource 201. In this event, the jobs are serially processed by the serially reusable resource 201. Thus, the currently processing job causes delay for the other jobs that are queued up after the currently processing job. Such a delay is called a contention event which can be a normal contention event if the amount of the delay consumes the expect amount of time and/or processing resources. However, the contention event may be an abnormal contention event if the job usage of the serially reusable resource 201 exceeds certain thresholds. This abnormal contention can be detected by implementing a system and method according to the disclosed one or more embodiments of the disclosure.

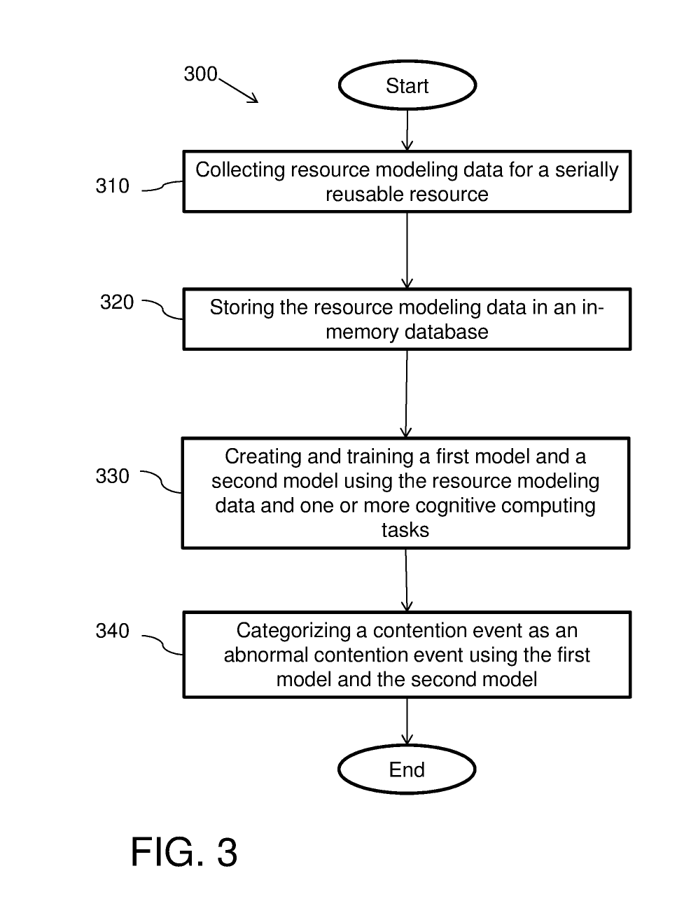

For example, FIG. 3 depicts a process flow of a method 300 for detecting abnormal contention in accordance with some embodiments of this disclosure. The method 300 includes collecting, using a processor, resource modeling data for a serially reusable resource, wherein the resource modeling data includes one or more of request count data and contention data (operation 310). The method 300 also includes storing, in a computer readable storage medium, the resource modeling data in an in-memory database (operation 320). Further, the method 300 includes creating and training, using the processor, a first model and a second model using the resource modeling data and one or more cognitive computing tasks (operation 330). Finally, the method 300 includes categorizing, using the processor, a contention event as an abnormal contention event using the first model and the second model (operation 340).

According to one or more embodiments, the method 300 may include creating and training, using the processor, a plurality of models in excess of two models. The plurality of models is created and trained using the resource modeling data and one or more cognitive computing tasks. For example, data can be collected as described herein based on counts and contention data. The data may also include information about the contention resource as well as waiters and blockers of that resource and times of requests and anything else that may be used for detecting contention. The collected data can be use with multiple modeling algorithms to create multiple predictions. One or more predictions may be created (i.e., modeled) for each type of modeling algorithm used. Further, categorizing an abnormal contention event may be done using all of the modeled predictions. Alternatively, a single one of the predictions may be used to determine an abnormal contention individually. Using multiple predictions to detect and categorize an abnormal contention can include confidence levels for each, followed by algorithmically using the values and their confidence levels to produce a final result. For example, the final result may itself be an average with its own confidence level. Further, according to another embodiment, if the confidence level is below a desired threshold, the predictions can be recalculated using updated data and/or the models can be recalculated.

According to one or more embodiments, the one or more cognitive computing tasks include a regression task that categorizes the contention event as an abnormal contention event using the request count data. The one or more cognitive computing tasks may also include a classification task that predicts the contention event is the abnormal contention event based on the contention data. Further, the one or more cognitive computing tasks may also include a clustering task that predicts the contention event is the abnormal contention event based on cluster mapping the resource modeling data and comparing the proximity of the contention event when mapped against the cluster mapping.

According to another embodiment, the regression task includes using statistical analysis to create a curve based on multiple independent variables from the resource modeling data and fitting a dependent variable from the collected contention data to determine whether the contention event is an abnormal contention event based on the fitting of the dependent variable to the curve.

According to another embodiment, the classification task includes structuring the resource modeling data into a tree structure with nodes and branches and using the structured resource modeling data to determine a group the contention event belongs to, wherein the group is one selected from a group consisting of an abnormal contention event group and a normal contention event group.

According to another embodiment, the first model and the second model are each selected from a group consisting of a number of different model options. For example the first and second model may be selected from among a first regression model of rates of serialization request over time and a second regression model of rates of requests based on workloads run per system. Further, the first and second model may be selected from among a first clustering model of patterns of serialization requests across multiple resources and resource types and a second clustering model of patterns of contention across multiple resources and resource types. Also, the first and second models may be selected from among a first classification model of contention based on individual resources, a second classification model of contention based on length of ownership, and a third classification model of contention based on length of waiting.

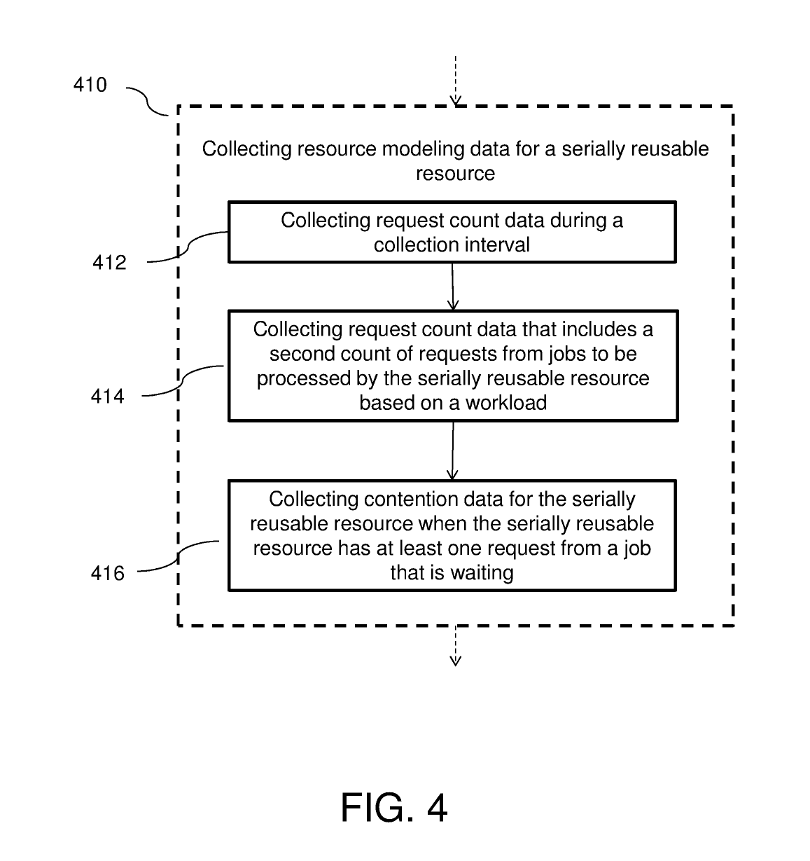

FIG. 4 depicts a process flow of collecting resource modeling data 410 for a method for detecting abnormal contention, substantially similar to the method 300 of FIG. 3, in accordance with some embodiments of this disclosure. Collecting resource modeling data 410 includes collecting request count data during a collection interval (operation 412). The request count data includes one or more of a first count of requests from jobs to be processed by the serially reusable resource during the collection interval. Collecting resource modeling data 410 also includes collecting request count data that includes a second count of requests from jobs to be processed by the serially reusable resource based on a workload, (operation 414). The workload is defined by one or more of CPU usage of the request, memory usage of the request, and time usage of the request. According to another embodiment, a workload can be expanded to include a combination of programs and transactions driving the programs. Finally, collecting resource modeling data 410 includes collecting contention data for the serially reusable resource when the serially reusable resource has at least one request from a job waiting (operation 416). The contention data includes a first list that includes jobs waiting to be processed by the serially reusable resource and time values of how long each job has been waiting, a second list that includes jobs holding the serially reusable resource and time values for the length of ownership, job identification information for each job on the first list and second list, and a duplicate count of duplicate contention events.

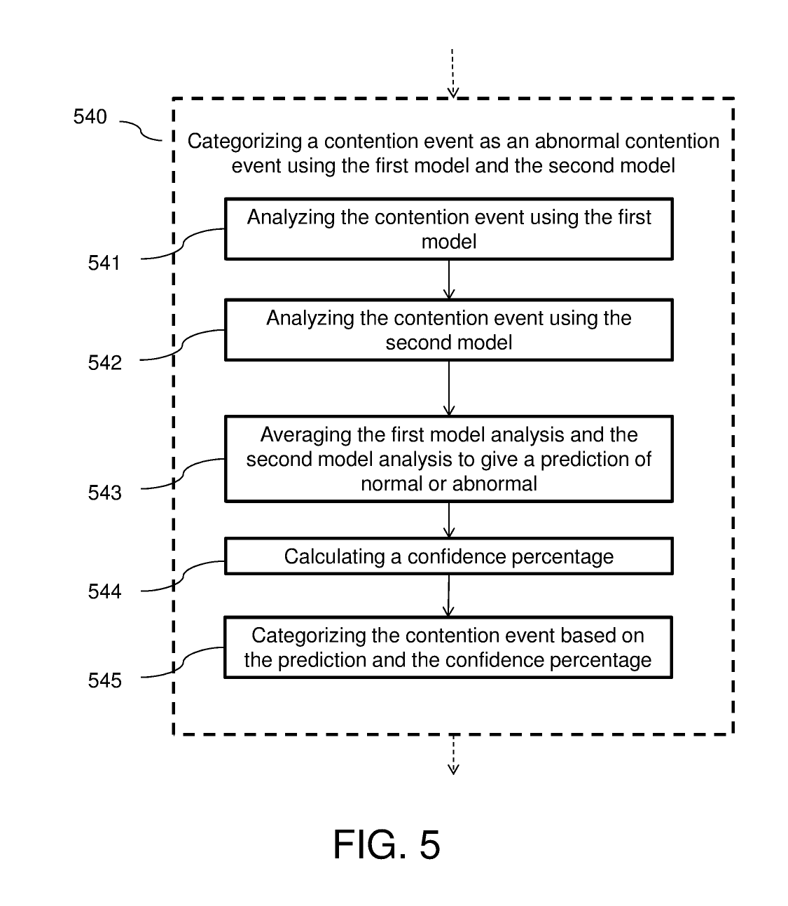

FIG. 5 depicts a process flow of categorizing a contention event 540 for a method for detecting abnormal contention, substantially similar to the method 300 of FIG. 3, in accordance with some embodiments of this disclosure. Categorizing a contention event 540 includes analyzing the contention event using the first model (operation 541) and analyzing the contention event using the second model (operation 542). Further, categorizing a contention event 540 includes averaging the first model analysis and the second model analysis to give a prediction of normal or abnormal (operation 543). The prediction can include a weighted average based on one or more factors including at least one from a group consisting of a confidence level of predicted result, a confidence level of the cognitive computing task used, and a combination of factors. Categorizing a contention event 540 also includes calculating a confidence percentage (operation 544). Finally, categorizing a contention event 540 includes categorizing the contention event based on the prediction and the confidence percentage (operation 545).

According to another exemplary embodiment, categorizing a contention event may include different operations. For example, categorizing a contention event may similarly include analyzing the contention event using the first model and analyzing the contention event using the second model. Categorizing a contention event may then further include correlating the first model analysis and the second model analysis and categorizing the contention event based on the correlation.

According to one or more embodiments, multiple types of data may be collected during every collection interval to be used for multiple types of modeling to aid in detecting abnormalities. For example, a first type of data that may be collected are counts of requests. One such count includes counts of requests for each serialization resource per collection interval. Another count type includes counts of requests for each serialization resources based on workloads that are based on the amount of overall CPU used per address space requesting the resource per collection interval.

According to one or more embodiments, a number of different counts could be collected depending on the specific serially reusable resource and timing values of the system. For example, in one embodiment, these counts are calculated per resource. In another embodiment, these counts are calculated per resource per job. In another embodiment, these counts are calculated per all jobs in a system in the cluster. In another embodiment, these counts are calculated per cluster.

According to one or more embodiments, another type of data that can be collected includes contention information. Contention information can be defined for each resource that has at least one job waiting where the contention information may then be collected along with all the identifier information. For example, the contention information may include a list of jobs waiting and the time they have been waiting. The contention information may include a list of jobs holding and the length of ownership. The contention information may include a count of duplicate contention events.

Further, according to one or more embodiments, different types of standard cognitive computing tasks to analyze the historical data and predict if a contention related delay that is abnormal may be used. Each involves periodically making a model of the data and training the model. This model is then used to quickly categorize contention events as normal or abnormal.

According to an embodiment, a regression task to categorize or predict abnormality based on the “counts of requests” data may be used. Regression is a form of statistical analysis where users try and fit a dependent variable (for example, a binary variable: normal (0) or abnormal contention (1)) to a curve based on multiple independent variables. Once the historical data is fit to a curve the analysis of how far off the contention is from that curve is used to determine and categorize the contention.

According to another embodiment, a classification task to categorize or predict abnormality based on the contention information data may be used. Classification is a cognitive computing technique where a data set is modeled as a special structure in order to determine or predict what “group” a future data element may belong to. Often, a tree structure is used. Each branch of the tree is based on the value of one attribute of the data element. The tree building algorithm uses measures of node impurity to determine the optimal attributes and values to split when making the next branch.

According to another embodiment, the third is a clustering task to identify groups of related contention events, so they may be treated as one entity. Clustering analysis is when a data set is modeled as plot points on an axis; repeatedly using different attributes of a data element as variables to look for clusters (points are close together). One or more embodiments can use the groups to establish simple cause and effect relationships present in the historical data. These groups and relationships may be stored in the historical data as they are discovered.

According to one or more embodiments, multiple different models of this historical data can be used. For example, a first regression model that models rates of serialization requests over time. This model can include specific models of rates for specific days/weeks/months/years. A second regression model may be used that models rates of requests based on workloads run per system. A first clustering model that models patterns of serialization requests across multiple resources and resource types may be used. A second clustering model may be used that models patterns of contention across multiple resources and resource types. A first classification model may be used that models contention based on individual resource. A second classification model may be used that models contention based on length of ownership. Finally, a third classification model may be used that models contention based on length of waiting. According to another embodiment, a combination of any two or more of these models may be used together. These models will be dynamically built and trained using the accumulated historical data at periodic intervals.

According to another embodiment, incoming contention events can be run through these models, and their results averaged together to give a prediction of normal or abnormal with a calculated confidence percentage. If the confidence is too low, the models can be regenerated from the historical data as well.

According to one or more embodiments, each model may use a different technique as indicated thereby modeling data multiple ways using multiple combinations of variables. Then at detection time, running the new data elements through a variety of algorithms and taking the average of them all comes up with a more balanced prediction. This approach may help mitigate the risk that one model is over trained to its training data set.

According to one or more embodiments, avoiding excessive overhead may be provided by setting the periods between building/training new models to be fairly far apart (i.e. once a week). This would necessitate a larger data store for historical data which can be provided by, for example, the strategic direction of larger memory for mainframes, and 64-bit addressability.

In one embodiment the models above would be for a single system in a cluster. In another embodiment, the models above would be for a group of related systems in the cluster that perform similar workloads. In another embodiment, the models above would pertain to the entire cluster of systems. Further, in accordance with one or more embodiments, accurately understanding normal system behavior and thus recognize outliers may be provided by using one or more of the above disclosed techniques and embodiments. Outlier contention events can be presented to a contention processor which may perform analysis or take further action to resolve the contention without operator intervention as disclosed in one or more of the embodiments.

According to one or more embodiments, the serially reusable resources are protected by using abstract serialization resources such as locks, mutexes, enqueues, latches, etc. When a program wants to request access to a serially reusable resource, they do so by obtaining permission through the abstract serialization resource of the serially reusable resource. If the serially reusable resource is not available, the serialization resource queues a request for the program to wait for the serially reusable resource. The requesting program waits until the serialization resource communicates that the serially reusable resource is granted to the program. When the program is finished with the serially reusable resource the program releases the serially reusable resource so it may be granted to any other waiting programs. At that time the request is removed from the queue.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Java, Smalltalk, C++, or the like, and conventional procedural programming languages, such as the “C” programming language or similar programming languages. The computer readable program instructions may execute entirely on the user's computer, partly on the user's computer, as a standalone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A computer implemented method for detecting abnormal contention, the computer implemented method comprising:
collecting, using a processor, resource modeling data for a serially reusable resource, wherein the resource modeling data includes one or more of request count data and contention data;
storing, in a computer readable storage medium, the resource modeling data in an in-memory database;
creating and training, using the processor, a first model and a second model using the resource modeling data and one or more cognitive computing tasks; and
categorizing, using the processor, a contention event as an abnormal contention event using the first model and the second model.

2. The computer implemented method of claim 1, wherein the serially reusable resource is selected from a group consisting of: a computer memory, a computer processor, a computer program, a computer data bus, a file, a row in a database table, a piece of code that touches certain memory objects, a database structure in memory, a control block in memory, a shared device, a data set on a shared device, data buffers, and registers.

3. The computer implemented method of claim 1, wherein collecting resource modeling data comprises:
collecting request count data during a collection interval, wherein the request count data includes one or more of a first count of requests from jobs to be processed by the serially reusable resource during the collection interval;
collecting request count data that includes a second count of requests from jobs to be processed by the serially reusable resource based on a workload, wherein the workload is defined by one or more of CPU usage of the request, memory usage of the request, and time usage of the request; and
collecting contention data for the serially reusable resource when the serially reusable resource has at least one request from a job that is waiting.

4. The computer implemented method of claim 3,
wherein the contention data includes a first list that includes jobs waiting to be processed by the serially reusable resource and time values of how long each job has been waiting, a second list that includes jobs holding the serially reusable resource and time values for a length of ownership, job identification information for each job on the first list and second list, and a third count of duplicate contention events.

5. The computer implemented method of claim 1, wherein the one or more cognitive computing tasks includes
a regression task that categorizes the contention event as an abnormal contention event using the request count data,
wherein the regression task includes using statistical analysis to create a curve based on multiple independent variables from the resource modeling data and fitting a dependent variable from the contention data to determine whether the contention event is an abnormal contention event based on fitting of the dependent variable to the curve.

6. The computer implemented method of claim 1, wherein the one or more cognitive computing tasks includes:
a classification task that categorizes the contention event as an abnormal contention event based on the contention data,
wherein the classification task includes structuring the resource modeling data into a tree structure with nodes and branches and using the structured resource modeling data to determine a group the contention event belongs to, wherein the group is one selected from a group consisting of an abnormal contention event group and a normal contention event group.

7. The computer implemented method of claim 1, wherein the one or more cognitive computing tasks includes:
a clustering task that categorizes the contention event as an abnormal contention event based on cluster mapping the resource modeling data and comparing a proximity of the contention event when mapped against the cluster mapping.

8. The computer implemented method of claim 1, wherein the first model and the second model are each selected from a group consisting of:
a first regression model of rates of serialization request over time;
a second regression model of rates of requests based on workloads run per system;
a first clustering model of patterns of serialization requests across multiple resources and resource types;
a second clustering model of patterns of contention across multiple resources and resource types;
a first classification model of contention based on individual resources;
a second classification model of contention based on length of ownership; and
a third classification model of contention based on length of waiting.

9. The computer implemented method of claim 1, wherein categorizing the contention event comprises:
analyzing the contention event using the first model;
analyzing the contention event using the second model;
correlating the first model analysis and the second model analysis; and
categorizing the contention event based on the correlation.

10. The computer implemented method of claim 1, wherein categorizing the contention event comprises:
analyzing the contention event using the first model;
analyzing the contention event using the second model;
averaging the first model analysis and the second model analysis to give a determination of normal or abnormal, wherein the determination includes a weighted average based on one or more factors including at least one from a group consisting of a confidence level of a determined result, a confidence level of the cognitive computing task used, and a combination of factors;
calculating a confidence percentage; and
categorizing the contention event based on the determination and the confidence percentage.

11. A system for detecting abnormal contention, the system comprising:
a memory having computer readable instructions; and
one or more processors for executing the computer readable instructions, the computer readable instructions comprising:
collecting resource modeling data for a serially reusable resource, wherein the resource modeling data includes one or more of request count data and contention data;
storing, in the memory, the resource modeling data in an in-memory database;
creating and training a first model and a second model using the resource modeling data and one or more cognitive computing tasks; and
categorizing a contention event as an abnormal contention event using the first model and the second model.

12. The system of claim 11, wherein the serially reusable resource is selected from a group consisting of: a computer memory, a computer processor, a computer program, a computer data bus, a file, a row in a database table, a piece of code that touches certain memory objects, a database structure in memory, a control block in memory, a shared device, a data set on a shared device, data buffers, and registers.

13. The system of claim 11, wherein collecting resource modeling data comprises:
collecting request count data during a collection interval, wherein the request count data includes one or more of a first count of requests from jobs to be processed by the serially reusable resource during the collection interval;
collecting request count data that includes a second count of requests from jobs to be processed by the serially reusable resource based on a workload, wherein the workload is defined by one or more of CPU usage of the request, memory usage of the request, and time usage of the request; and
collecting contention data for the serially reusable resource when the serially reusable resource has at least one request from a job that is waiting,
wherein the contention data includes a first list that includes jobs waiting to be processed by the serially reusable resource and time values of how long each job has been waiting, a second list that includes jobs holding the serially reusable resource and time values for a length of ownership, job identification information for each job on the first list and second list, and a third count of duplicate contention events.

14. The system of claim 11, wherein the one or more cognitive computing tasks include one or more from a group consisting of:
a regression task that categorizes the contention event as an abnormal contention event using the request count data,
wherein the regression task includes using statistical analysis to create a curve based on multiple independent variables from the resource modeling data and fitting a dependent variable from the contention data to determine whether the contention event is an abnormal contention event based on fitting of the dependent variable to the curve;
a classification task that categorizes the contention event as an abnormal contention event based on the contention data,
wherein the classification task includes structuring the resource modeling data into a tree structure with nodes and branches and using the structured resource modeling data to determine a group the contention event belongs to, wherein the group is one selected from a group consisting of an abnormal contention event group and a normal contention event group; and
a clustering task that categorizes the contention event as an abnormal contention event based on cluster mapping the resource modeling data and comparing a proximity of the contention event when mapped against the cluster mapping.

15. The system of claim 11, wherein the first model and the second model are each selected from a group consisting of:
a first regression model of rates of serialization request over time;
a second regression model of rates of requests based on workloads run per system;
a first clustering model of patterns of serialization requests across multiple resources and resource types;
a second clustering model of patterns of contention across multiple resources and resource types;
a first classification model of contention based on individual resources;
a second classification model of contention based on length of ownership; and
a third classification model of contention based on length of waiting.

16. The system of claim 11, wherein categorizing the contention event comprises:
analyzing the contention event using the first model;
analyzing the contention event using the second model; and
correlating the first model analysis and the second model analysis.

17. The system of claim 11, wherein categorizing the contention event comprises:
analyzing the contention event using the first model;
analyzing the contention event using the second model;
averaging the first model analysis and the second model analysis to give a determination of normal or abnormal, wherein the determination includes a weighted average based on one or more factors including at least one from a group consisting of a confidence level of a determined result, a confidence level of the cognitive computing task used, and a combination of factors;
calculating a confidence percentage; and
categorizing the contention event based on the determination and the confidence percentage.

18. A computer program product for detecting abnormal contention, the computer program product comprising a computer readable storage medium having program instructions embodied therewith, the program instructions executable by a processor to cause the processor to:
collect resource modeling data for a serially reusable resource, wherein the resource modeling data includes one or more of request count data and contention data;
store the resource modeling data in an in-memory database;
create and train a first model and a second model using the resource modeling data and one or more cognitive computing tasks; and
categorize a contention event as an abnormal contention event using the first model and the second model.

19. The computer program product for detecting abnormal contention of claim 18, wherein categorizing the contention event comprises program instructions executable by the processor to cause the processor to:
analyze the contention event using the first model;
analyze the contention event using the second model;
average the first model analysis and the second model analysis to give a determination of normal or abnormal, wherein the determination includes a weighted average based on one or more factors including at least one from a group consisting of a confidence level of a determined result, a confidence level of the cognitive computing task used, and a combination of factors;
calculate a confidence percentage; and
categorize the contention event based on the determination and the confidence percentage.

20. The computer program product for detecting abnormal contention of claim 18,
wherein the one or more cognitive computing tasks include one or more from a group consisting of:
a regression task that categorizes the contention event as an abnormal contention event using the request count data,
wherein the regression task includes using statistical analysis to create a curve based on multiple independent variables from the resource modeling data and fitting a dependent variable from the contention data to determine whether the contention event is an abnormal contention event based on fitting of the dependent variable to the curve;
a classification task that categorizes the contention event as an abnormal contention event based on the contention data,
wherein the classification task includes structuring the resource modeling data into a tree structure with nodes and branches and using the structured resource modeling data to determine a group the contention event belongs to, wherein the group is one selected from a group consisting of an abnormal contention event group and a normal contention event group; and
a clustering task that categorizes the contention event as an abnormal contention event based on cluster mapping the resource modeling data and comparing a proximity of the contention event when mapped against the cluster mapping, and
wherein the first model and the second model are each selected from a group consisting of:
a first regression model of rates of serialization request over time;
a second regression model of rates of requests based on workloads run per system;
a first clustering model of patterns of serialization requests across multiple resources and resource types;
a second clustering model of patterns of contention across multiple resources and resource types;
a first classification model of contention based on individual resources;
a second classification model of contention based on length of ownership; and
a third classification model of contention based on length of waiting.
